(19) United States
(12) Patent Application Publication
(10) Pub. No.: US 2026/0317537 A1
(43) Pub. Date: Oct. 15, 2026

(54) CURED EPOXY RESIN AND PREPARATION METHOD THEREFOR

(71) Applicant: SOOCHOW UNIVERSITY, Suzhou (CN)

(72) Inventors: Yingfeng TU, Suzhou (CN); Wenlu CAO, Suzhou (CN); Diyuan ZHENG, Suzhou (CN); Xiaohong LI, Suzhou (CN)

(73) Assignee: SOOCHOW UNIVERSITY, Suzhou (CN)

(21) Appl. No.: 19/688,071

(22) Filed: May 26, 2026

Related U.S. Application Data
(63) Continuation of application No. PCT/CN2025/103275, filed on Jun. 25, 2025.

(30) Foreign Application Priority Data
Dec. 26, 2024 (CN) 202411938591.7

(51) Int. Cl. C08L 63/00

(52) U.S. Cl. CPC C08L 63/00

(57) ABSTRACT

The invention provides a cured epoxy resin and a preparation method therefor. The cured epoxy resin is obtained by curing an epoxy resin in the presence of toughening modifiers and curing agents. The toughening modifier is a poly(ether-ester-amide) multiblock copolymer including aliphatic polyether, polyester and polyamide block components, which is soluble in the epoxy resin to prepare a modified epoxy resin, and is educed and undergoes microphase separation when the epoxy resin is cured. Due to the small size of microphase separation, the cured epoxy resin is highly transparent. By adding the toughening modifier, the toughness, impact strength and tensile strength of the cured epoxy resin are all significantly improved. The problems of insufficient toughness, brittleness of the cured epoxy resin and its composites thereof are effectively overcome, and a high-transparency epoxy resin can be prepared.

### FIELD OF THE INVENTION

The present invention relates to the technical field of epoxy resins, and in particular to a cured epoxy resin and a preparation method therefor.

### DESCRIPTION OF THE RELATED ART

Cured epoxy resins, due to their excellent mechanical and chemical stability, heat resistance, corrosion resistance, electric insulativity and bonding performance, are a most widely used thermosetting material. They are widely used in anti-corrosive coatings, binders, electronic packaging materials, electrical insulation materials, high-performance composite materials, and other fields. However, the cured epoxy resins are highly crosslinked in structure, and have disadvantages, such as poor impact resistance, poor fracture toughness, and poor fatigue resistance, which seriously limits the use of epoxy resins in some important fields, such as advanced composite materials, structural adhesives, ultra-low temperature toughness materials and so on. Therefore, the toughening modification of epoxy resins has become a research hotspot.

Currently, according to the toughening mechanism, the toughening systems for cured epoxy resins can be divided into a homogeneous toughening system and a heterogeneous toughening system. The homogeneous toughening system is mainly realized by introducing a flexible segment onto epoxy resin. This method not only has some difficulties in the design and synthesis of raw materials, but also obviously reduces the strength of epoxy resin. The heterogeneous toughening system involves the phase separation between the modifier and the epoxy resin, with which a multiphase structure is usually formed, where the size of the phase structure is at submicron or micron scale.

A block copolymer can contain blocks that are miscible and immiscible in epoxy resins, which provides a new method to toughen epoxy resins. By adjusting the composition and structure of a block copolymer, a remarkable toughening effect can be achieved.

At present, there are many studies on diblock and triblock copolymers as toughening agents for epoxy resins. For example, CN115160515A discloses the use of an amphiphilic liquid crystal block copolymer in an epoxy resin toughening agent. The amphiphilic liquid crystal block copolymer is obtained by the atom transfer radical polymerization or reversible addition-fragmentation chain transfer solution polymerization of poly(ethylene glycol) methyl ether methyl methacrylate or 2-(dimethylamino)ethyl methacrylate with a biphenyl liquid crystal monomer or a diphenyl ethylene liquid crystal monomer. Although the toughening system has a good toughening effect on epoxy resins, a large amount of organic solvent is consumed in the synthesis process, the preparation cost is high, and the synthesis process is environmentally unfriendly. Therefore, it is difficult to be used in the toughening of an epoxy resin in the practical production process.

CN102348757A discloses a thermosetting composition containing an amphiphilic block copolymer and a polyol in combination and a thermoset product thereof. The used toughening agents for epoxy resins focus on an amphiphilic polyether block copolymer with blocks miscible and immiscible with epoxy resin, which has a good toughening effect on epoxy resins. However, the toughening effect of a multiblock copolymer in epoxy resins is not described in the invention. Moreover, the level of phase separation of the diblock copolymer is large, and the toughening modification effect on epoxy resins is limited.

Compared with a diblock copolymer, the multiblock copolymer has better toughening effect because of the shuttling of its blocks in multiple micro-domains. Moreover, due to the much smaller size of micro-phase separation domains which leads to the weaker light scattering, the cured epoxy resin formed has high transparency.

Based on the above analysis, there is an urgent need to develop a multiblock copolymer as a toughening modifier for epoxy resin, which can be used to toughen cured epoxy resin, by enhancing its tensile strength and impact strength while achieving a high transparency at the same time.

### SUMMARY OF THE INVENTION

To solve the above technical problems, the invention provides a cured epoxy resin and a preparation method therefor. An epoxy resin is toughening modified by a multiblock copolymer. The epoxy resin toughening modifier is a poly(ether-ester-amide) multiblock copolymer including aliphatic polyether, polyester and polyamide blocks. The polyether and polyester blocks have a good dissolvability in the epoxy resin. The multiblock copolymer is compatible in the epoxy resin, and is soluble in the epoxy resin at normal or elevated temperature to prepare a correspondingly modified epoxy resin. The multiblock copolymer is educed and undergoes microphase separation when the epoxy resin is cured. Due to the small size of microphase separation domains in the system, a high-transparency and high-toughness epoxy resin is prepared. After the epoxy resin toughening modifier is added, the toughness, impact strength and tensile strength of the cured epoxy resin are all obviously improved without significant influence on the transparency.

The present invention is accomplished through the following technical solutions.

A first object of the present invention is to provide a cured epoxy resin, obtained by curing a modified epoxy resin. The modified epoxy resin includes: an epoxy resin, an epoxy resin toughening modifier and a curing agent.

In an embodiment of the present invention, the epoxy resin toughening modifier is a poly(ether-ester-amide) multiblock copolymer; and the poly(ether-ester-amide) multiblock copolymer includes aliphatic polyether, aliphatic polyester and aliphatic polyamide blocks.

In the multiblock copolymer, the content of the aliphatic polyether block is 60 wt %-90 wt %; the content of the aliphatic polyester block is 10 wt %-30 wt %; the content of the aliphatic polyamide block is 1 wt %-12 wt %, and the total content of the various components is 100 wt %.

In an embodiment of the present invention, the epoxy resin is selected from a bisphenol A epoxy resin with an epoxy value of 0.1-0.6, including, but not limited to one or more of E-12, E-44, E-51, and BE-188EL.

In an embodiment of the present invention, the curing agent is an amine curing agent; and the amine curing agent is selected from the group consisting of ethylene diamine, hexamethylene diamine diethylene triamine, triethylene tetraamine, tetraethylene pentaamine, isophorone diamine and any combination thereof.

In an embodiment of the present invention, the poly(ether-ester-amide) multiblock copolymer has a chemical structural formula below:

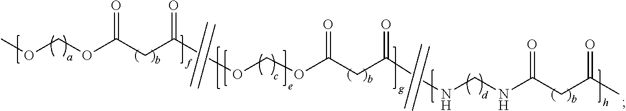

where a is any integer from 2 to 6; b is any integer from 2 to 11; c is any integer from 2 to 4; d is any integer from 5 to 12; e is any integer from 4 to 68; f, g, and h depend on the contents of the aliphatic polyester, polyether and polyamide blocks in the multiblock copolymer, respectively. The content of the aliphatic polyether block is 60 wt %-90 wt %, the content of the aliphatic polyester block is 10 wt %-30 wt %, the content of the aliphatic polyamide block is 1 wt %-12 wt %, and the total content of the various components is 100 wt %. The multiblock copolymer has a number average molecular weight of 6000 g/mol-50000 g/mol.

In an embodiment of the present invention, the aliphatic polyether block is preferably selected from polyethylene oxide, poly(tetramethylene oxide) and any combination thereof; and the polyether block has a number average molecular weight of 200 g/mol-3000 g/mol.

In an embodiment of the present invention, the aliphatic polyester block is a polyester derived from aliphatic dicarboxylic acid and diol; and is preferably selected from poly(ethylene adipate), poly(butylene succinate), poly(ethylene brassylate), poly(ethylene dodecanedioate) and any combination thereof.

In an embodiment of the present invention, the aliphatic polyamide is preferably selected from the group consisting of Nylon 1013, Nylon 613, Nylon 1213, Nylon 104, Nylon 1012 and any combination thereof.

In an embodiment of the present invention, the weight ratio of the epoxy resin to the epoxy resin toughening modifier is 200:1-10:1; and the molar ratio of the reactive group from the curing agent to the epoxy group of the epoxy resin is 2:1-1:2, and preferably 1:1.

A second object of the present invention is to provide a method for preparing a modified cured epoxy resin, which includes the following steps: mixing an epoxy resin with a toughening modifier, heating to 60° C.-150° C., stirring for 20 min-1 h, to mix the two components uniformly, and then cooling to room temperature; adding a curing agent and mixing uniformly, and then curing in a mold with heating to obtain the cured epoxy resin.

Compared with the prior techniques, the technical solution of the present invention has the following advantages:
1. The present invention provides a cured epoxy resin and a preparation method therefor. The epoxy resin toughening modifier provided in the present invention is a poly(ether-ester-amide) multiblock copolymer, in which the polyether and polyester blocks, as flexible blocks, have good compatibility with the epoxy resin, and can provide good flexibility and impact strength; and the polyamide block is poorly compatible with the epoxy resin. Therefore, the toughening modifier provided in the present invention can not only maintain good compatibility in the epoxy resin and effectively improve its dispersion in the epoxy resin, but also be educed and undergo microphase separation when the epoxy resin is cured, so that the toughness, impact strength and tensile strength of the cured epoxy resin are obviously improved.
2. After the epoxy resin toughening modifier of the present invention acts on the epoxy resin, due to the small size of microphase separation domains in the system, the cured epoxy resin is highly transparent, so the transparency of the epoxy resin is not affected.

### BRIEF DESCRIPTION OF THE DRAWINGS

To make the disclosure of the present invention more comprehensible, the present invention will be further described in detail by way of specific embodiments of the present invention with reference the accompanying drawings, in which:

FIG. 1 is a stress-strain curve of a cured epoxy resin in Example 1 of the present invention;

FIG. 2 is a stress-strain curve of a cured epoxy resin in Example 3 of the present invention;

FIG. 3 is a stress-strain curve of a cured epoxy resin in Example 4 of the present invention;

FIG. 4 is a stress-strain curve of a cured epoxy resin in Comparative Example 1 of the present invention;

FIG. 5 compares the transparency of cast strips of cured epoxy resins in the examples of the present invention; and

FIG. 6 compares the impact resistance and tensile performance of cured epoxy resins in the examples of the present invention and cured epoxy resins in Comparative Example 1.

### DETAILED DESCRIPTION OF THE PREFERRED EMBODIMENTS

The present invention will be further described below with reference to the accompanying drawings and specific examples, so that those skilled in the art can better understand and implement the present invention; however, the present invention is not limited thereto.

Unless otherwise stated, the experimental methods given in examples below are all conventional methods. The materials, and reagents involved in the examples are commercially available unless otherwise specified.

The CAS numbers of organic reagents used in the present invention are as follows.

TABLE 1

| Reagent | CAS |
|---|---|
| BE-188EL epoxy resin | 61788-97-4 |
| Isophorone diamine | 2855-13-2 |
| Ethylene brassylate | 105-95-3 |
| Ethylene dodecanedioate | 54982-83-1 |
| Polyethylene glycol | 25322-68-3 |
| Poly(tetramethylene oxide) | 25190-06-1 |
| 1,6-hexamethylene diamine | 124-09-4 |
| 1,10-decamethylenediamine | 646-25-3 |
| 1,12-dodecanediamine | 2783-17-7 |
| Tetra-n-butyl titanate | 5593-70-4 |
| m-cresol | 108-39-4 |

In the following examples of the present invention, the poly(ether-ester-amide) multiblock copolymer is prepared by cascade polycondensation-coupling ring-opening polymerization. The specific preparation method can be made reference to Chinese Patent No. CN116425983B entitled “High-impact-resistance poly(ether-ester-amide) thermoplastic elastomer and preparation method thereof”.

The poly(ether-ester-amide) multiblock copolymer mBCP-1 is prepared by mixing ethylene brassylate (10.0 g), polyethylene glycol (20.0 g, molecular weight 2000 g/mol), 1,10-decamethylenediamine (0.6 g) and tetra-n-butyl titanate (15.0 μL), with nitrogen inlet, mechanically stirring, and reacting at 220° C. for 60 min. The mBCP-1 is characterized by quantitative ¹H NMR experiments. The results show that the polyester block is poly(ethylene brassylate) (PEB), and has a content of 21%; the polyether block is poly(ethylene oxide) (PEO), and has a content of 73%; and the polyamide block is Nylon 1013, and has a content of 6%. The molecular weight of mBCP-1 is 6.5 kg/mol.

The poly(ether-ester-amide) multiblock copolymer mBCP-2 is prepared by mixing ethylene brassylate (10.0 g), polyethylene glycol (20.0 g, molecular weight 2000 g/mol), 1, 10-decamethylenediamine (0.6 g) and tetra-n-butyl titanate (15.0 μL), with nitrogen inlet, mechanically stirring, heating to 240° C., then reacting for 60 min in vacuum. The mBCP-2 is tested by quantitative ¹H NMR. The results show that the polyester block is poly(ethylene brassylate) (PEB), and has a content of 25%; the polyether block is PEO, with a content of 72%; and the polyamide block is Nylon 1013, with a content of 3%. The molecular weight of mBCP-2 is 21.1 kg/mol.

The preparation method for the poly(ether-ester-amide) multiblock copolymer mBCP-3 is similar to that for mBCP-2, except that 1,10-decamethylenediamine is replaced by equivalent 1,6-hexamethylene diamine. The mBCP-3 is tested by quantitative 1H NMR. The results show that the polyester block is PEB, and has a content of 16%; the polyether block is PEO, and has a content of 80%; and the polyamide block is Nylon 613, and has a content of 4%. The molecular weight of mBCP-3 is 28.8 kg/mol.

The preparation method for the poly(ether-ester-amide) multiblock copolymer mBCP-4 is similar to that for mBCP-1, except that ethylene brassylate (10.0 g), polyethylene glycol (30.0 g, molecular weight 3000 g/mol), 1, 10-decamethylenediamine (0.8 g) and tetra-n-butyl titanate (20.0 μL) are mixed to prepare mBCP-4. The mBCP-4 is tested by quantitative ¹H NMR. The results show that the polyester block is poly(ethylene brassylate) (PEB), and has a content of 13%; the polyether block is polyethylene oxide (PEO), and has a content of 83%; and the polyamide block is Nylon 1013, and has a content of 4%. The molecular weight of mBCP-4 is 11.7 kg/mol.

The preparation method for the poly(ether-ester-amide) multiblock copolymer mBCP-5 is similar to that for mBCP-1, except that ethylene brassylate (10.0 g), polyethylene glycol (20.0 g, molecular weight 600 g/mol), 1,12-dodecanediamine (0.6 g) and tetra-n-butyl titanate (15.0 μL) are mixed to prepare mBCP-5. The mBCP-5 is tested by quantitative ¹H NMR. The results show that the polyester block is poly(ethylene brassylate) (PEB), and has a content of 22%; the polyether block is polyethylene oxide (PEO), and has a content of 75%; and the polyamide block is Nylon 1213, and has a content of 3%. The molecular weight of mBCP-5 is 15.9 kg/mol.

The preparation method for the poly(ether-ester-amide) multiblock copolymer mBCP-6 is similar to that for mBCP-1, except that ethylene brassylate is replaced by equivalent cyclic oligo (butylene succinate) s. The mBCP-6 is tested by quantitative ¹H NMR. The results show that the polyester block is poly(butylene succinate) (PBS), and has a content of 27%; the polyether block is polyethylene oxide (PEO), and has a content of 70%; and the polyamide block is Nylon 104, and has a content of 3%. mBCP-6 has an intrinsic viscosity of 0.32 dL/g.

The preparation method for the poly(ether-ester-amide) multiblock copolymer mBCP-7 is similar to that for mBCP-1, except that ethylene brassylate (10.0 g), polyethylene glycol (20.0 g, molecular weight 2000 g/mol), 1, 10-decamethylenediamine (1.5 g) and tetra-n-butyl titanate (15.0 μL) are mixed to prepare mBCP-7. The mBCP-7 is tested by quantitative ¹H NMR. The results show that the polyester block is poly(ethylene brassylate) (PEB), and has a content of 18%; the polyether block is polyethylene oxide (PEO), and has a content of 71%; and the polyamide block is Nylon 1013, and has a content of 11%. The molecular weight of mBCP-7 is 6.1 kg/mol.

The preparation method for the poly(ether-ester-amide) multiblock copolymer mBCP-8 is similar to that for mBCP-1, except that ethylene dodecanedioate (10.0 g), poly(tetramethylene oxide) (20.0 g, molecular weight 1000 g/mol), 1, 10-decamethylenediamine (0.6 g) and tetra-n-butyl titanate (15.0 μL) are mixed to prepare mBCP-8. The mBCP-8 is tested by quantitative ¹H NMR. The results show that the polyester block is poly(ethylene dodecanedioate) (PED), and has a content of 18%; the polyether block is poly(tetramethylene oxide) (PTMO), and has a content of 78%; and the polyamide block is Nylon 1012, and has a content of 4%. The molecular weight of mBCP-8 is 12.1 kg/mol.

The preparation method for the poly(ether-ester-amide) multiblock copolymer mBCP-9 is similar to that for mBCP-2, except that ethylene brassylate (16.5 g), poly(tetramethylene oxide) (20.0 g, molecular weight 1000 g/mol), 1, 10-decamethylenediamine (3.5 g) and tetra-n-butyl titanate (8.0 μL) are mixed to prepare mBCP-9. The mBCP-9 is tested by quantitative ¹H NMR. The results show that the polyester block is poly(ethylene brassylate) (PEB), and has a content of 21%; the polyether block is poly(tetramethylene oxide) (PTMO), and has a content of 60%; and the polyamide block is Nylon 1013, and has a content of 19%.

The preparation method for the poly(ether-ester-amide) multiblock copolymer mBCP-10 is similar to that for mBCP-1, except that ethylene brassylate (25.8 g), poly(tetramethylene oxide) (3.0 g, molecular weight 1000 g/mol), 1, 10-decamethylenediamine (4.2 g) and tetra-n-butyl titanate (6.0 μL) are mixed to prepare mBCP-10. The mBCP-10 is tested by quantitative ¹H NMR. The results show that the polyester block is poly(ethylene brassylate) (PEB), and has a content of 61%; the polyether block is poly(tetramethylene oxide) (PTMO), and has a content of 11%; and the polyamide block is Nylon 1013, and has a content of 28%.

The preparation method for the poly(ether-ester-amide) multiblock copolymer mBCP-11 is similar to that for mBCP-1, except that ethylene brassylate (16.5 g), polyethylene glycol (10.0 g, molecular weight 2000 g/mol), 1, 10-decamethylenediamine (3.5 g) and tetra-n-butyl titanate (6.0 μL) are mixed to prepare mBCP-11. The mBCP-11 is tested by quantitative ¹H NMR. The results show that the polyester block is poly(ethylene brassylate) (PEB), and has a content of 41%; the polyether block is polyethylene oxide (PEO), and has a content of 32%; and the polyamide block is Nylon 1013, and has a content of 27%.

In the following examples of the present invention, the intrinsic viscosity of the product is measured by Ubbelohde viscometer, m-cresol is used as a solvent, and the temperature is 25° C.

In the following examples of the present invention, the tensile strength of the cured epoxy resin is tested by Instron-3365 universal material testing machine (drawing rate: 10 mm/min, temperature: 20.0° C., humidity: 70.0%).

In the following examples of the present invention, according to standard GB/T 2567-2021, the notched Charpy impact performance of the cured epoxy resin is tested by FPP-01A impact tester.

In the following examples of the present invention, the light transmittance of the cured epoxy resin is tested by Shimadzu UV-3150 UV-vis spectrophotometer (temperature: 25° C., wavelength: 600 nm).

### Example 1

A method for preparing a cured epoxy resin was provided in this example. The specific steps were as follows.

In this example, the epoxy resin toughening modifier was poly(ether-ester-amide) multiblock copolymer mBCP-1.

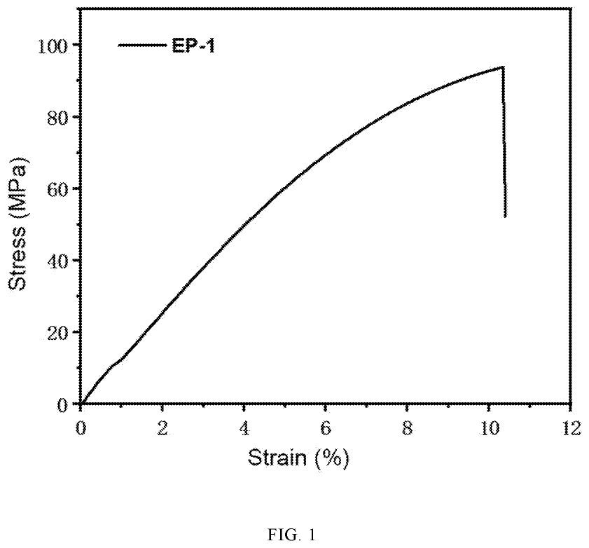

12.0 g of BE-188EL epoxy resin was mixed with 0.60 g of mBCP-1, heated to 70° C., stirred for 30 min, mixed uniformly, and then cooled to room temperature. 2.64 g of isophorone diamine was added and mixed uniformly. The system was cured at 40° C. for 1 h, and then at 80° C., 120° C., and 160° C. for 2 h respectively in sequence, to obtain cured epoxy resin EP-1, with a stress-strain curve as shown in FIG. 1.

The impact resistance and tensile strength of the cured epoxy resin were tested. The results are shown in Table 2. The light transmittance of the cured epoxy resin EP-1 is 94% relative to that of the pure epoxy resin (Comparative Example EP).

### Example 2

A method for preparing a cured epoxy resin was provided in this example. The epoxy resin toughening modifier was the same as that in Example 1, except that 12.0 g of BE-188EL epoxy resin was mixed with 0.24 g of mBCP-1, heated to 70° C., stirred for 1 h, mixed uniformly, and then cooled to room temperature; 2.64 g of isophorone diamine was added and mixed uniformly; and the system was then cured at 40° C. for 1 h, and then at 80° C., 120° C., and 160° C. for 2 h respectively in sequence, to obtain cured epoxy resin EP-2.

The impact resistance and tensile strength of the cured epoxy resin were tested. The results are shown in Table 2.

### Example 3

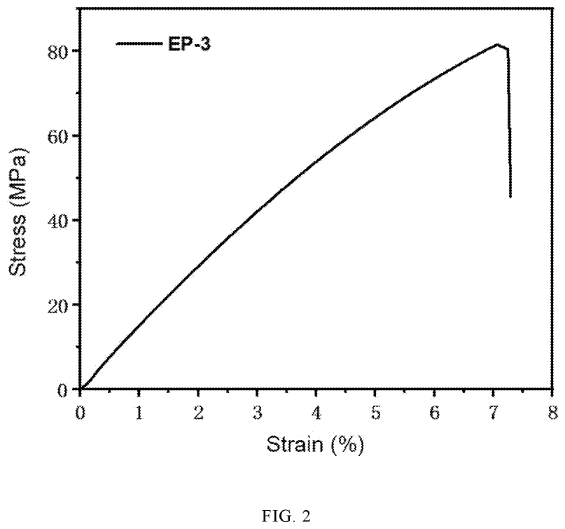

A method for preparing a cured epoxy resin was provided in this example. The epoxy resin toughening modifier was the same as that in Example 1, except that 12.0 g of BE-188EL epoxy resin was mixed with 0.12 g of mBCP-1, heated to 70° C. stirred for 20 min, mixed uniformly, and then cooled to room temperature; 2.64 g of isophorone diamine was added and mixed uniformly; and the system was then cured at 40° C. for 1 h, and then at 80° C., 120° C., and 160° C. for 2 h respectively in sequence, to obtain cured epoxy resin EP-3, with a stress-strain curve as shown in FIG. 2.

The impact resistance and tensile strength of the cured epoxy resin were tested. The results are shown in Table 2.

### Example 4

A method for preparing a cured epoxy resin was provided in this example. The specific steps were as follows.

In this example, the epoxy resin toughening modifier was poly(ether-ester-amide) multiblock copolymer mBCP-2.

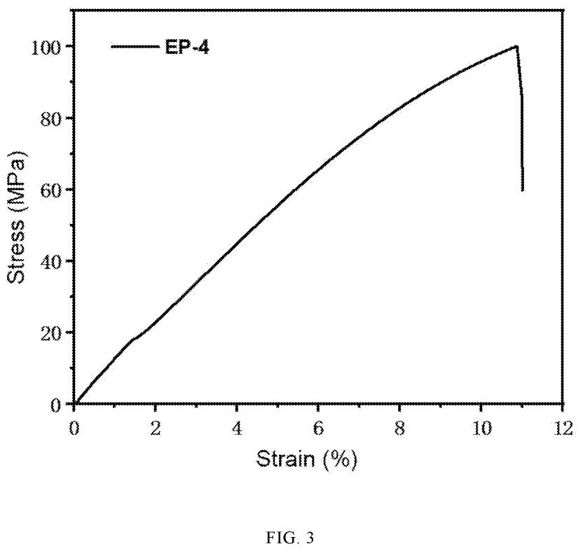

12.0 g of BE-188EL epoxy resin was mixed with 0.60 g of mBCP-2, heated to 130° C., stirred for 1 h, mixed uniformly, and then cooled to room temperature; 2.64 g of isophorone diamine was added and mixed uniformly; and the system was then cured at 40° C. for 1 h, and then at 80° C., 120° C., 160° C. for 2 h in sequence, to obtain cured epoxy resin EP-4, with a stress-strain curve as shown in FIG. 3.

The impact resistance and tensile strength of the cured epoxy resin were tested. The results are shown in Table 2. The light transmittance of the cured epoxy resin EP-4 is 83% relative to that of the pure epoxy resin (Comparative Example EP).

### Example 5

A method for preparing a cured epoxy resin was provided in this example. The specific steps were as follows.

In this example, the epoxy resin toughening modifier was poly(ether-ester-amide) multiblock copolymer mBCP-3.

The preparation process of the cured epoxy resin was similar to that in Example 4, except that the toughening modifier mBCP-2 was placed by equivalent toughening modifier mBCP-3, to obtain cured epoxy resin EP-5.

The impact resistance and tensile strength of the cured epoxy resin were tested. The results are shown in Table 2. The light transmittance of the cured epoxy resin EP-5 is 88% relative to that of the pure epoxy resin (Comparative Example EP).

### Example 6

A method for preparing a cured epoxy resin was provided in this example. The specific steps were as follows.

In this example, the epoxy resin toughening modifier was poly(ether-ester-amide) multiblock copolymer mBCP-4.

The preparation process of the cured epoxy resin was similar to that in Example 1, except that the toughening modifier mBCP-1 was replaced by equivalent toughening modifier mBCP-4, to obtain cured epoxy resin EP-6.

The impact resistance and tensile strength of the cured epoxy resin were tested. The results are shown in Table 2. The light transmittance of the cured epoxy resin EP-6 is 94% relative to that of the pure epoxy resin (Comparative Example EP).

### Example 7

A method for preparing a cured epoxy resin was provided in this example. The specific steps were as follows.

In this example, the epoxy resin toughening modifier was poly(ether-ester-amide) multiblock copolymer mBCP-5.

The preparation process of the cured epoxy resin was similar to that in Example 4, except that the toughening modifier mBCP-2 was replaced by equivalent toughening modifier mBCP-5, to obtain cured epoxy resin EP-7.

The impact resistance and tensile strength of the cured epoxy resin were tested. The results are shown in Table 2.

### Example 8

A method for preparing a cured epoxy resin was provided in this example. The specific steps were as follows.

In this example, the epoxy resin toughening modifier was poly(ether-ester-amide) multiblock copolymer mBCP-6.

The preparation process of the cured epoxy resin was similar to that in Example 1, except that the toughening modifier mBCP-1 was replaced by equivalent toughening modifier mBCP-6, to obtain cured epoxy resin EP-8.

The impact resistance and tensile strength of the cured epoxy resin were tested. The results are shown in Table 2. The light transmittance of the cured epoxy resin EP-8 is 89% relative to that of the pure epoxy resin (Comparative Example EP).

### Example 9

A method for preparing a cured epoxy resin was provided in this example. The specific steps were as follows.

In this example, the epoxy resin toughening modifier was poly(ether-ester-amide) multiblock copolymer mBCP-7.

The preparation process of the cured epoxy resin was similar to that in Example 1, except that the toughening modifier mBCP-1 was replaced by equivalent toughening modifier mBCP-7, to obtain cured epoxy resin EP-9.

The impact resistance and tensile strength of the cured epoxy resin were tested. The results are shown in Table 2.

### Example 10

A method for preparing a cured epoxy resin was provided in this example. The specific steps were as follows.

In this example, the epoxy resin toughening modifier was poly(ether-ester-amide) multiblock copolymer mBCP-8.

The preparation process of the cured epoxy resin was similar to that in Example 4, except that the toughening modifier mBCP-2 was replaced by equivalent toughening modifier mBCP-8, to obtain cured epoxy resin EP-10.

The impact resistance and tensile strength of the cured epoxy resin were tested. The results are shown in Table 2.

### Comparative Example 1

A method for preparing a cured epoxy resin was provided in this comparative example. The specific steps were as follows.

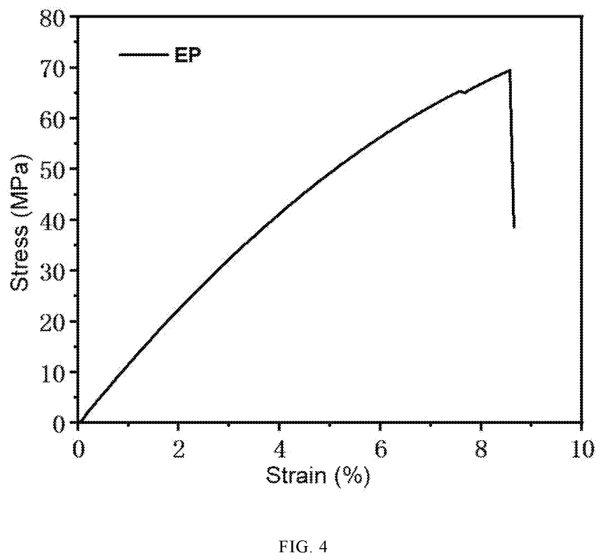

12.0 g of BE-188EL epoxy resin was mixed uniformly with 2.64 g of isophorone diamine. Then, the system was cured at 40° C. for 1 h, and then at 80° C., 120° C., and 160° C. for 2 h respectively in sequence, to obtain cured epoxy resin EP, with a stress-strain curve as shown in FIG. 4.

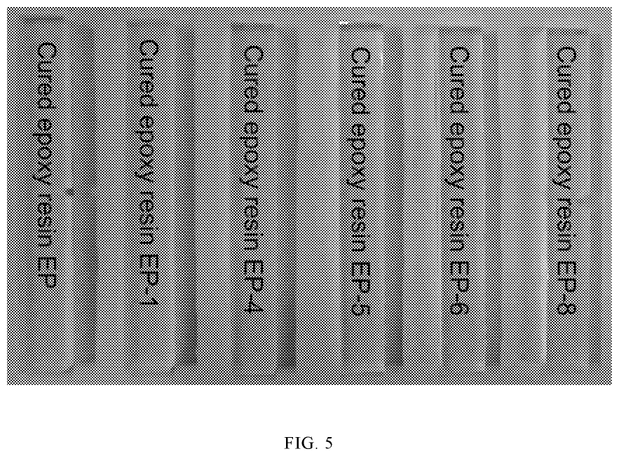

The impact resistance and tensile strength of the cured epoxy resin were tested. The results are shown in Table 2. As shown in FIG. 5, the light transmittance of modified cured epoxy resins EP-1, EP-6 and EP-8 is close to that of the comparative example, indicating that the epoxy resin still maintains a good light transmittance after the toughening agent is added.

### Comparative Example 2

The poly(ether-ester-amide) multiblock copolymer provided in this comparative example was poly(ether-ester-amide) multiblock copolymer mBCP-9. 12.0 g of BE-188EL epoxy resin was mixed with 0.60 g of mBCP-9, heated to 150° C., and stirred for 2 h. mBCP-9 was incompatible with the epoxy resin, and had no toughening modification effect on the epoxy resin.

### Comparative Example 3

The poly(ether-ester-amide) multiblock copolymer provided in this comparative example was poly(ether-ester-amide) multiblock copolymer mBCP-10.

12.0 g of BE-188EL epoxy resin was mixed with 0.60 g of mBCP-10, heated to 150° C., and stirred for 2 h. mBCP-10 was incompatible with the epoxy resin, and had no toughening modification effect on the epoxy resin.

### Comparative Example 4

The poly(ether-ester-amide) multiblock copolymer provided in this comparative example was poly(ether-ester-amide) multiblock copolymer mBCP-11.

12.0 g of BE-188EL epoxy resin was mixed with 0.60 g of mBCP-11, heated to 150° C., and stirred for 2 h. mBCP-11 was incompatible with the epoxy resin, and had no toughening modification effect on the epoxy resin.

TABLE 2
Impact toughness and tensile strength
of cured epoxy resin materials

| | Impact | Tensile |
|---|---|---|
| Sample | strength (kJ/m²) | strength (MPa) |
| Example 1 | 28.5 ± 2.7 | 95.3 ± 1.5 |
| Example 2 | 23.8 ± 3.4 | 84.3 ± 0.5 |
| Example 3 | 20.4 ± 4.0 | 86.1 ± 4.0 |
| Example 4 | 29.8 ± 0.7 | 85.8 ± 0.7 |
| Example 5 | 30.3 ± 2.8 | 93.4 ± 0.9 |
| Example 6 | 30.5 ± 2.0 | 87.7 ± 3.0 |
| Example 7 | 26.1 ± 3.3 | 92.4 ± 1.8 |
| Example 8 | 21.2 ± 0.3 | 88.7 ± 4.3 |
| Example 9 | 24.5 ± 2.3 | 96.1 ± 11 |
| Example 10 | 27.3 ± 6.9 | 78.2 ± 2.7 |
| Comparative Example 1 | 14.8 ± 3.1 | 68.4 ± 3.7 |

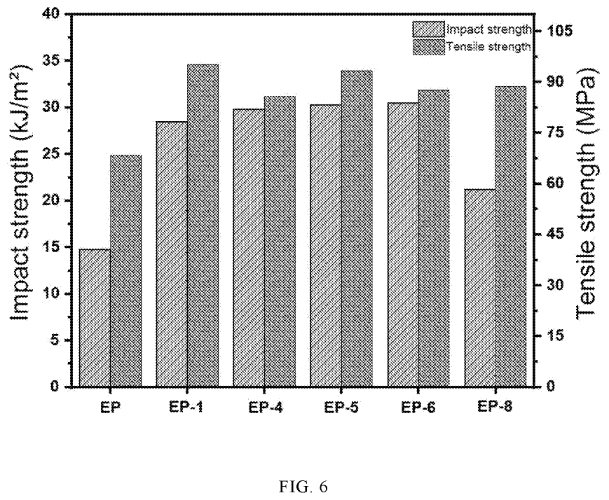

The impact resistance is used to characterize the toughness of the cured epoxy resin. As can be seen from Table 2, after adding the toughening modifier of the present invention, as shown in FIGS. 1-10, the toughness and strength of the cured epoxy resin are both improved significantly. The impact resistance is improved by 100% or higher, and the tensile strength is improved by 40% or higher, as shown in FIG. 6.

Apparently, the above-described embodiments are merely examples provided for clarity of description, and are not intended to limit the implementations of the present invention. Other variations or changes can be made by those skilled in the art based on the above description. The embodiments are not exhaustive herein. Obvious variations or changes derived therefrom also fall within the protection scope of the present invention.

What is claimed is:

1. A cured epoxy resin, obtained by curing a modified epoxy resin, wherein the modified epoxy resin comprises: an epoxy resin, a toughening modifier, and a curing agent;
the toughening modifier is a poly(ether-ester-amide) multiblock copolymer; the poly(ether-ester-amide) multiblock copolymer comprises aliphatic polyether, aliphatic polyester and aliphatic polyamide blocks; and
in the multiblock copolymer, the content of the aliphatic polyether block is 60 wt %-90 wt %; the content of the aliphatic polyester block is 10 wt %-30 wt %; the content of the aliphatic polyamide block is 1 wt %-12 wt %, and the total content of the aliphatic polyether, aliphatic polyester and aliphatic polyamide blocks is 100 wt %.

2. The cured epoxy resin according to claim 1, wherein the epoxy resin is selected from a bisphenol A epoxy resin with an epoxy value of 0.1-0.6; and the bisphenol A epoxy resin is selected from the group consisting of E-12, E-44, E-51, BE-188EL and any combination thereof.

3. The cured epoxy resin according to claim 1, wherein the curing agent is an amine curing agent; the amine curing agent is selected from the group consisting of ethylene diamine, hexamethylene diamine diethylene triamine, triethylene tetraamine, tetraethylene pentaamine, isophorone diamine and any combination thereof.

4. The cured epoxy resin according to claim 1, wherein the poly(ether-ester-amide) multiblock copolymer has a chemical structure formula of: 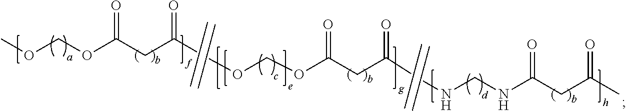
where a is any integer from 2 to 6; b is any integer from 2 to 11; c is any integer from 2 to 4; d is any integer from 5 to 12; e is any integer from 4 to 68; f, g, and h depend on the contents of the aliphatic polyester, the aliphatic polyether and the aliphatic polyamide blocks respectively; and the multiblock copolymer has a number average molecular weight of 6000 g/mol-50000 g/mol.

5. The cured epoxy resin according to claim 1, wherein the aliphatic polyether block is polyethylene oxide and/or poly(tetramethylene oxide); and the aliphatic polyether has a number average molecular weight of 200 g/mol-3000 g/mol.

6. The cured epoxy resin according to claim 1, wherein the aliphatic polyester block is a polyester derived from aliphatic dicarboxylic acid and diol; the polyester derived from aliphatic dicarboxylic acid and diol is selected from the group consisting of poly(ethylene adipate), poly(butylene succinate), poly(ethylene brassylate), poly(ethylene dodecanedioate) and any combination thereof.

7. The cured epoxy resin according to claim 1, wherein the aliphatic polyamide is selected from the group consisting of Nylon 1013, Nylon 613, Nylon 1213, Nylon 104, Nylon 1012 and any combination thereof.

8. The cured epoxy resin according to claim 1, wherein weight ratio of the epoxy resin to the epoxy resin toughening modifier is 200:1-10:1; and/or
molar ratio of the reactive group from curing agent to the epoxy group of the epoxy resin is 2:1-1:2.

9. The cured epoxy resin according to claim 1, wherein light transmittance of the cured epoxy resin is larger than 80% of that of the epoxy resin.

10. A method for preparing a cured epoxy resin, comprising:
mixing an epoxy resin with a toughening modifier, heating to 60° C.-150° C., stirring for 20 min-1 h to mix uniformly, and then cooling to room temperature; and
adding a curing agent and mixing uniformly, and then curing in a mold with heating to obtain the cured epoxy resin.
